(19) United States
(12) Patent Application Publication
(10) Pub. No.: US 2009/0091143 A1
(43) Pub. Date: Apr. 9, 2009

(54) MECHANISM FOR LOCKING A WINDOW OR DOOR IN A CLOSED POSITION

(76) Inventor: Remi Emiel VAN PARYS, Waregem (BE)

Correspondence Address: BACON & THOMAS, PLLC, 625 SLATERS LANE, FOURTH FLOOR, ALEXANDRIA, VA, 22314-1176, US

(21) Appl. No.: 12/244,090

(22) Filed: Oct. 2, 2008

(30) Foreign Application Priority Data
Oct. 4, 2007 (BE) 2007/0477

(51) Int. Cl. E05C 3/22

(52) U.S. Cl. 292/224; 292/195; 292/229; 292/219

(57) ABSTRACT

A mechanism for locking a window (5) or door in a closed position, consisting of a bolt (11) with a tap (7) and a driving mechanism (12) to shift the bolt (11) with the tap (7) in an axial direction between two positions corresponding to a locked and a non-locked position respectively of the window (5) or door, wherein the mechanism (1) is provided with a release which is possible to move the tap (7) from the locked position into its non-locked position without using the driving mechanism (12).

The present invention concerns a mechanism for locking a a window or door in a closed position.

In particular, the invention concerns a mechanism of the type which is designed to be built in the space between the fixed frame and the hinge-mounted leaf of a window or door and which mainly consists of a bolt with a tap and a driving mechanism to push the bolt with the tap in the axial direction between two positions corresponding to a locked and a non-locked position of the window or the door respectively.

Such a mechanism is mounted for example on the fixed frame and it can co-operate with a fixed locking point on the leaf or it can also be mounted on the leaf whereby it can co-operate with a fixed locking point on the fixed frame in that case.

By shifting the bolt of the mechanism by means of the driving mechanism, the tap will mesh behind the locking point, thus locking the window or the door. In order to unlock the window or the door, the tap is withdrawn from the locking point by means of the driving mechanism, such that the window or the door can be opened.

A disadvantage of such a known mechanism is that, when the driving mechanism fails, for example due to a short circuit or power failure in the case of an electric drive, or when it is jammed, for example due to rust formation, accumulation of dirt or the like, the tap can no longer be withdrawn from its locking point, such that the window or the door will need to be forced in order to be able to open the window or the door and thus get access to the mechanism in order to repair or replace it.

It is clear that the window or door cannot be forced without any damage.

The present invention aims to remedy the above-mentioned and other disadvantages.

To this end, the invention concerns a mechanism of the above-mentioned type which is provided with a release which makes it possible to move the tap manually or in another way from the above-mentioned locked position into a non-locked position without making use of the driving mechanism.

This makes it possible, even when the driving mechanism is defective or jammed, to nevertheless withdraw the tap from the locking point in order to unlock the window.

The release of the mechanism is preferably accessible via a slot between the fixed frame and the moving leaf of a closed window or door, such that in case of emergency, the mechanism can be easily unlocked manually in order to open the window without having to force the frame or the leaf of the window or door.

According to a preferred embodiment, the release is excited by a spring, such that the release is automatically activated following a simple operation.

The release is preferably such that it is reversible and makes it possible to easily move the tap from the unlocked position back into the locked position, such that the mechanism for locking a window or door can be made operational again in a very simple manner.

The mechanism can also be applied to the lock and tilting mechanism of a tilting window.

In order to better explain the characteristics of the invention, the following preferred embodiments of a mechanism according to the invention for locking a window or door in a closed position are described as an example only without being limitative in any way, with reference to the accompanying drawings, in which:

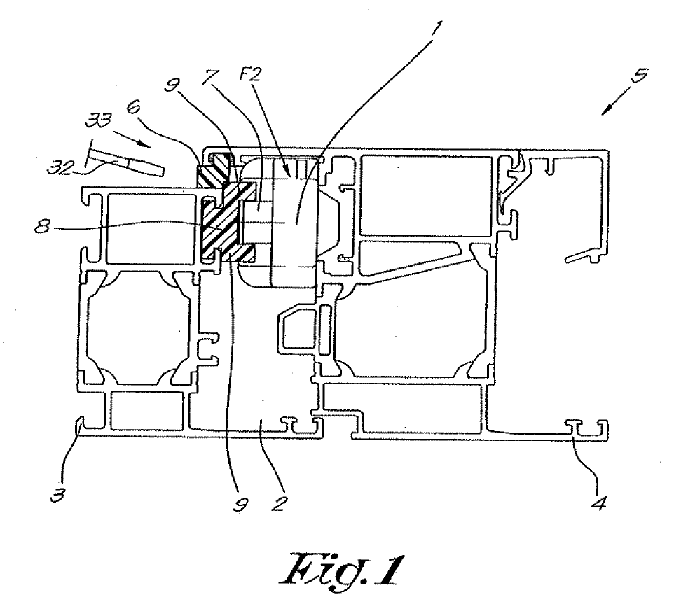

FIG. 1 is a section of the frame and the leaf of a window in between which has been provided a mechanism according to the invention for locking the window;

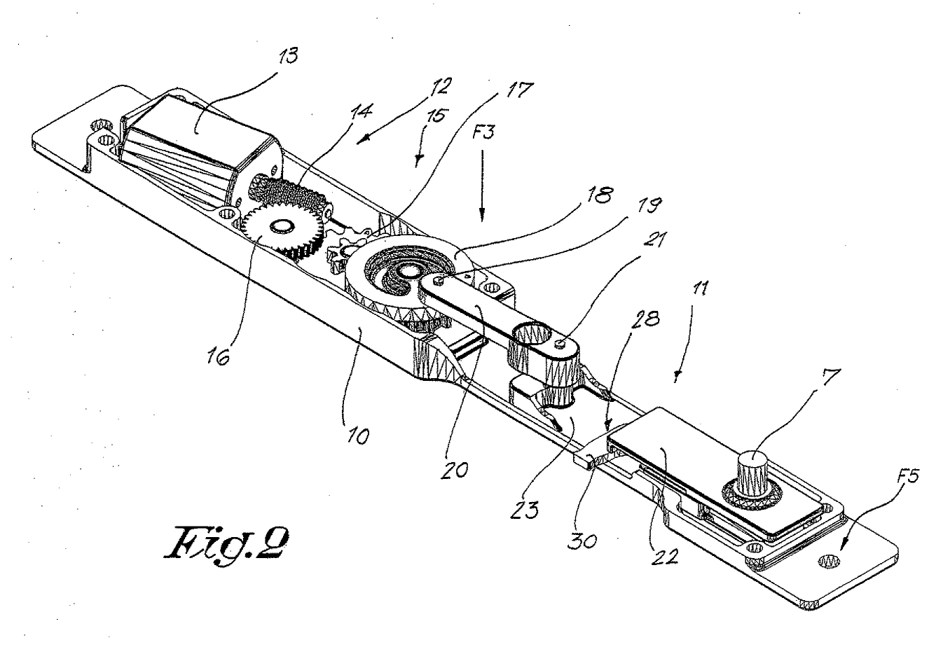

FIG. 2 represents the mechanism according to the invention, indicated by F2 in FIG. 1, to a larger scale and seen in perspective;

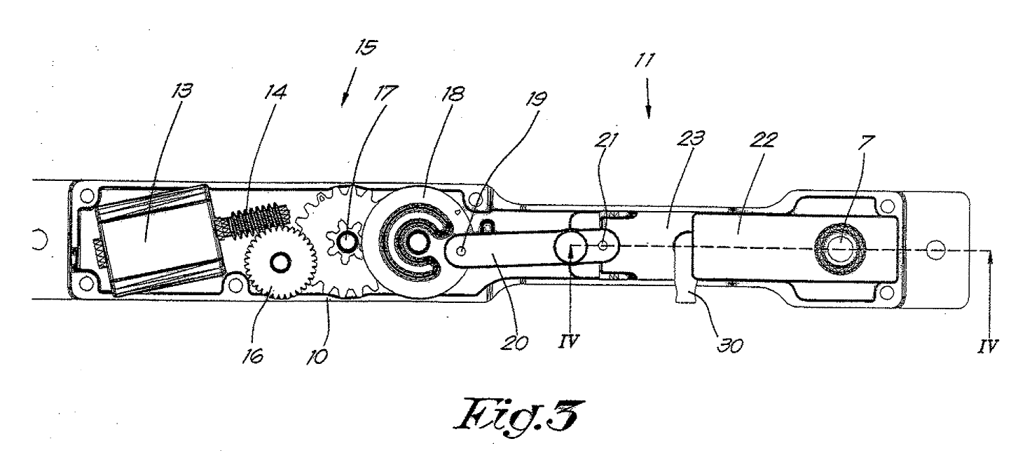

FIG. 3 is a view according to arrow F3 in FIG. 2;

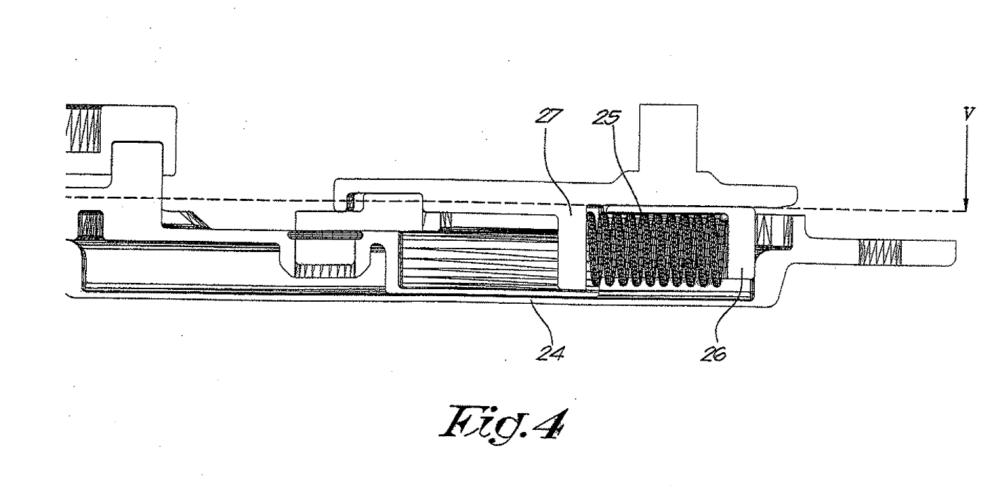

FIG. 4 is a section according to line IV-IV in FIG. 3;

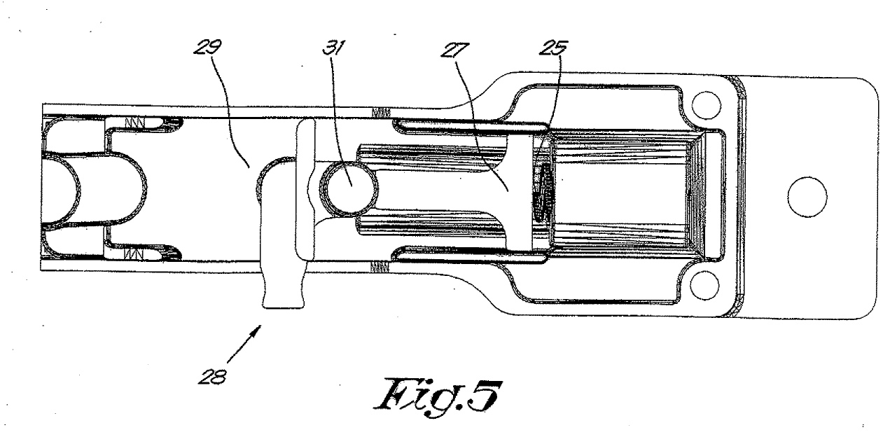

FIG. 5 is a section according to line V-V in FIG. 4;

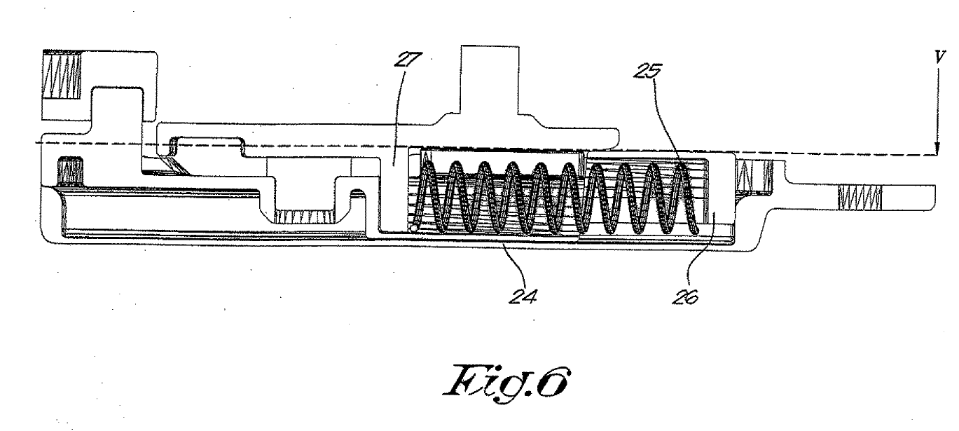

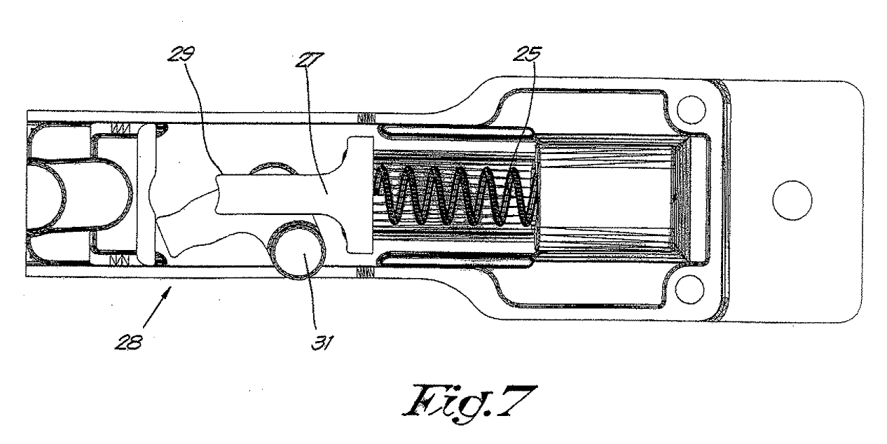

FIG. 6 and FIG. 7 respectively represent a view analogous to that in FIGS. 4 and 5, but for another position;

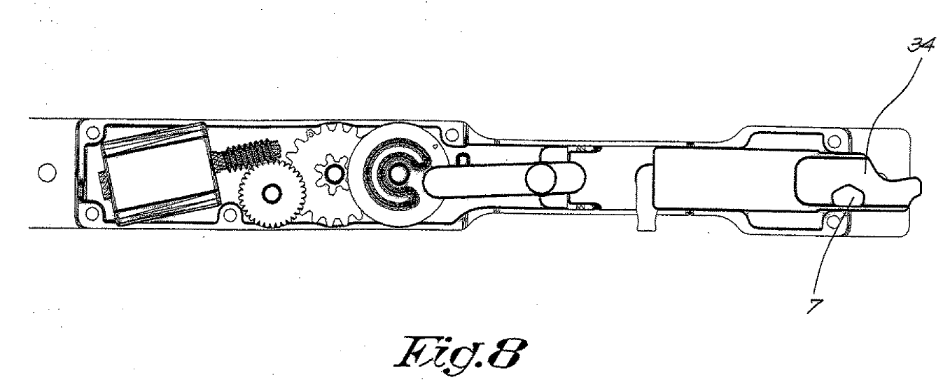

FIG. 8 represents a variant of FIG. 3.

FIG. 1 represents a mechanism 1 according to the invention, mounted in the space 2 between a profile 3 of the fixed frame and a profile 4 of a window's 5 leaf.

Both profiles 3 and 4 have been made windproof and waterproof in relation to each other by means of sealings 6.

In the given example, the mechanism 1 is fixed to the profile 3 of the leaf and it is provided with a tap 7 which can co-operate in a sliding manner with a locking point 8 which is fixed on the profile 2 of the frame and which is formed of, in this case, a U-shaped piece of profile with legs 9 in between which the tap 7 can mesh in the locked position, as represented in FIG. 1.

As is represented in greater detail in FIGS. 2 to 5, the mechanism 1 mainly consists of a base 10 with which the mechanism 1 can be fixed to the window 5 and on which has been provided a bolt 11, provided with the above-mentioned tap 7, which can be made to shift in the axial direction by means of a driving mechanism 12.

The driving mechanism 12 is preferably built of an electric drive in the form of the motor 13 which is provided with a worm 14 on its driven shaft 14 which drives a gear wheel transmission 15.

The gear wheel transmission 15 consists of a whole of three co-operating gear wheels, i.e. a first double gear wheel 16 which works in conjunction with the worm 14 on the one hand, and meshes with a second double gear wheel 17 on the other hand which in turn co-operates with a third gear wheel 18 which is provided with an eccentric shaft 19 on which a connecting rod 20 has been provided with one far end in a freely hinging manner, whereby this connecting rod 20 is connected in a freely hinging manner with its other far end 21 to a shaft 21 which is fixed to the bolt 11.

Preferably, the worm 14 is made of messing and the first gear wheel 16 co-operating with it is made of zamak.

The tap 7 of the bolt 11 is in this case part of a carriage 22 which can slide in the axial direction of the bolt 11 in relation to the actual bolt 11 which is formed of a base plate 23.

The base plate 23 is provided with a recessed part 24 in which has been provided a spring 25 between a sealing wall 26 of the recessed part 24 and a stop 27 provided under the carriage 22 and which extends in the above-mentioned recessed part 24.

The spring 25 is tightened between the above-mentioned sealing wall 26 and the stop 27, in such a way that the spring 25 tends to push the carriage 22 away with the tap 7 in the direction of the driving mechanism 12.

The mechanism 1 is further provided with an angular element 28 which can rotate in its angular point round a shaft 29 on the base plate 23 of the bolt 11 with a first leg forming an operating element 30 protruding laterally from the base 10 with which the angular element 28 can be rotated manually, and a second leg which can serve as a cam 31 to push the carriage 22 with the tap 7 away from the driving mechanism 12 against the force of the spring 25.

FIG. 5 shows the position in which the operating element 30 stands at right angles to the sliding direction of the bolt 11 and whereby the carriage 22 with the tap 7 is locked in relation to a locked position for normal use whereby the tap 7 is situated at a maximum distance from the driving mechanism 12.

The angular element 28 serves as a release for the mechanism 1, whereby, when the operating element 30 is turned away from the above-mentioned position at right angles, the cam 31 is also turned, as a result of which the carriage 22 with the tap 7 can freely move in the direction of the driving mechanism 12.

The working and the use of the mechanism 1 according to the invention is very simple and as follows.

The situation represented in FIGS. 2 to 5 corresponds to the locked position whereby the window 5 is locked in the closed position.

In this case, the bolt 11 is maximally removed from the driving mechanism 12 and the carriage 22 is locked in its most extended position, whereby the tap 7 is being held between the legs 9 of the U-shaped element forming the locking point 8.

In order to unlock the window 5, one only has to drive the driving mechanism 12 in one direction by applying a voltage to the electric motor 13, as a result of which the gear wheel transmission 15 is driven and the connecting rod 20 withdraws the bolt 11, together with the carriage 22 and the tap 7, from the locked position in the direction of the driving mechanism 12.

As soon as the bolt 11 has been withdrawn over a sufficient distance to withdraw the tap 7 past the locking point 8, the tap 7 will no longer be held between the legs 9 and, consequently, the leaf of the window 5 can be freely opened.

Of course, this movement supposes that the driving mechanism 12 is operative.

Indeed, should the driving mechanism 12 be defective or jammed for any reason, the window can no longer be opened.

However, thanks to the release according to the invention, it is nevertheless still possible to open the window 5.

One only has to move the operating element 30, for example by means of a tool 32 such as a screwdriver, to turn the angular element 28 away from the locked position of the carriage 22, such that the carriage 22 with the tap 7, under the influence of the force of the spring 25, is pushed away in the direction of the driving mechanism 12.

As a result, the tap 7 is automatically drawn away from the locking point 8, as a result of which the window 5 can be opened again, even in case of a defective or jammed driving mechanism 12.

The operating element 30 of the above-mentioned release is preferably accessible via the slot 33 between the profile 3 of the fixed frame and the slot 4 of the closed window's 5 leaf.

As a result, said operating element 30 will be easily accessible by pushing the sealing 6 at the slot 33 away by means of the tool 32.

As the window 5 can be opened at all times, it is possible to do the necessary repairs or replacements in case of a defective or jammed driving mechanism 12, without having to force open the window in any way.

It is clear that the mechanism can be put back in its operational position by inverting the unlocking action by turning the operating element 30 back into its normal position at right angles, as a result of which the cam 31 pushes back the carriage into the locked, tightened position, ready for use again for the normal locking of the window 5 with the driving mechanism 12.

Naturally, such a mechanism can also be applied in case of a tilting window, whereby the carriage 22 is in this case provided with an appropriately formed head 34, as is represented for example in FIG. 7, which is part of the tilting mechanism of the window 5.

Other embodiments of releases are not excluded.

Such another release might for example consist in making one of the gear wheels 16-17-18 of the above-mentioned gear wheel transmission 15 such that it can shift over its axis, whereby, in order to unlock the mechanism 1, one only has to shift the gear wheel concerned over its axis to unlock it from other gear wheels, as a result of which the bolt 11 can freely shift so as to remove the tap 7 from the locking point 8. For the normal working of this embodiment, a spring can be used which holds the gear wheel in a position whereby the gear wheel meshes with the other gear wheels.

An alternative embodiment consists in providing the connecting rod 20 in a sliding manner on one of its shafts 19 and 21 or on both shafts, making it possible to lift the connecting rod 20 from one or both shafts in order to provide for a disconnection between the driving mechanism 12 and the bolt 11, as a result of which the bolt 11 can be freely moved so as to draw the tap 7 from the locking point 8 into the unlocked position, either or not supported by the action of a spring which pushes the bolt 11 in the direction of the driving mechanism 12.

Yet another embodiment might consist in providing the bottom side 36 of the base plate 23 of the bolt 11 with teeth which can mesh in teeth provided on the top side of the base 10, whereby a spring or the like pushes the base plate 23 of the bolt 11 against the base 10 such that, when it is necessary to release the mechanism 1, one only has to lift the base plate 23 from the base 10 in order to pull the teeth loose.

A simple variant might consist in providing a strong spring between the base plate 23 and the carriage 22 which pushes the carriage 22 away together with the tap 7 from the driving mechanism 12 into a locked position, whereby it would be sufficient, in order to release the mechanism 1, to draw the carriage 22 away, as of this spring-enforced position, against the action of the spring, from the locking point 8, for example by working on a laterally protruding operating element of the tap 7 or of the carriage 22.

It is clear that also in the alternative embodiments, the release can be reversed in a very simple manner in order to bring the tap 7 back into its normal position of use.

Although, in what precedes, the tap 7 is always provided on the bolt 11 of the mechanism 1 and the locking point 8 is provided on the window 5, it is not excluded for the tap 7 to be provided on the window 5, while the locking point 8 is situated on the bolt 11 of the mechanism 1. Also, the description and the claims should be read in the sense that the tap 7 can be replaced by the locking point 8 and vice versa.

It is clear that the driving mechanism 12 should not necessarily be an electric drive, but that also other, more conventional drives are not excluded.

The present invention is by no means restricted to the embodiments described by way of example and represented in the accompanying drawings; on the contrary, such a mechanism according to the invention for locking a window or door in a closed position can be made in all sorts of shapes and dimensions while still remaining within the scope of the invention.

1. A mechanism for locking a window (5) or door in a closed position, comprising a bolt (11) with a tap (7) and a driving mechanism (12) to shift the bolt (11) with the tap (7) in an axial direction between two positions corresponding to a locked and a non-locked position respectively of a window (5) or door; and a release which enables movement of the tap (7) from the locked position into a non-locked position without using the driving mechanism (12).

2. Mechanism according to claim 1, wherein the release is accessible via a slot (33) between a fixed frame and a moving leaf of a closed window (5) or door.

3. Mechanism according to claim 1, wherein the release is biased by a spring (25).

4. Mechanism according to claim 1, wherein the tap (7) of the bolt (11) is moveable in relation to the bolt (11) and in relation to a base plate (23) of the bolt (11); and the spring (25) is arranged to push the tap (7) towards a specific position corresponding to an unlocked or locked position.

5. Mechanism according to claim 4, wherein the tap (7) is located on a carriage (11) which is also provided with a part (34) of a mechanism which enables a window (5) to tilt.

6. Mechanism according to claim 1, wherein the tap (7) is provided with a laterally protruding operating element.

7. Mechanism according to claim 3, wherein the release comprises a cam (31) which is disposed in a rotating manner on a shaft of the bolt (11) and which can rotate, by means of an operating element (30), between a position in which the tap (7) is jammed in the locked position and a position in which the tap (7) is released and is pushed out of the locked position by means of the spring (22).

8. Mechanism according to claim 7, wherein the cam (31) and the operating element (30) are formed of an angular element (28) which is disposed on the shaft (29) in a manner so that it can rotate about an angle.

9. Mechanism according to claim 1, wherein the driving mechanism (12) comprises an electric drive.

10. Mechanism according to claim 9, wherein the drive comprises an electric motor (13) which is provided with a worm (13) on its driven shaft which is arranged to drive a gear wheel transmission (15) in a manner so that, on a gear wheel (18) of the gear wheel transmission (15), there is provided a connecting rod (20) with one far end in a hinging manner on an eccentric shaft (19), which connecting rod (20) is hinge-mounted to the bolt (11) of the mechanism (1) at its other end.

11. Mechanism according to claim 10, wherein the gear wheel transmission (15) comprises three co-operating gear wheels, including a first double gear wheel (16) which works in conjunction with the worm (14), on the one hand, and said first double gear wheel meshes with a second double gear wheel (17), on the other hand, which in turn co-operates with a third gear wheel (18) which is connected via the shaft (19) to the connecting rod (20).

12. Mechanism according to claim 11, wherein the worm (14) is made of messing, and the first gear wheel (16) co-operates with the worm, which is made of zamak.

13. Mechanism according to claims 10, wherein at least one of the gear wheels (15-16-17) of the gear wheel transmission (15) is shiftable over its shaft and the release is achieved when a respective gear wheel is shifted so as to interrupt its coupling with another gear wheel.

14. Mechanism according to claim 11, wherein the shifting gear wheel (15-16-17) is movable into a position by means of a spring, so that the gear wheel meshes with the other gear wheels.

15. Mechanism according to claim 10, wherein the connecting rod (20) is provided in a shifting manner at one or both far ends on the shafts (19-21) with which it is hinge-mounted with the gear wheel transmission (15) or with the bolt (11), whereby, in view of the release, the connecting rod (20) can be disconnected from one or both shafts (19-20) by lifting the connecting rod (20).

16. Mechanism according to claim 13, wherein the connecting rod (20) is held in a coupled position by means of a spring.

17. Mechanism according to claim 1, wherein the release is such that it can be reversed and enables movement of the tap (7) from an unlocked position into a locked position.
